(19) United States
(12) Patent Application Publication
(10) Pub. No.: US 2004/0201748 A1
(43) Pub. Date: Oct. 14, 2004

(54) Extended image digital photography

(76) Inventors: Tim Goldstein, Loveland, CO (US); Gregory A. Brake, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/954,598

(22) Filed: Sep. 12, 2001

(51) Int. Cl. H04N 5/262

(52) U.S. Cl. 348/231.99

(57) ABSTRACT

A digital camera is provided with a system for capturing at least one image of a scene, a system for displaying the captured image, system for cropping the displayed image, and system for storing an uncropped portion of the displayed image. Also provided is a method of controlling a digital camera including the steps of receiving at least one captured image from a photosensor, displaying the captured image, receiving cropping instructions for the displayed image, and storing an uncropped portion of the displayed image.

### TECHNICAL FIELD

The technology disclosed here generally relates to photography, and more particularly, to extended image digital photography.

### BACKGROUND

European Patent Application No. 858,208 (applied for by Eastman Kodak Company and corresponding to U.S. patent application Ser. No. 796,350, filed Jul. 2, 1997) is incorporated by reference here. This reference discloses a method of producing a digital image by capturing at least two electronic images and then processing these images in order to provide a combined image with improved characteristics. A dual lens camera is used to form the two separate images that are first stored in temporary digital storage within the camera. The stored images are then transformed to a central processing unit where they are converted to a common color space, number of pixels, global geometry, and local geometry before being combined and printed.

U.S. Pat. No. 5,940,641 to McIntyre et al. (also assigned to Eastman Kodak Company) is also incorporated by reference here. McIntyre et al. disclose a method and apparatus for making a single panoramic image of a scene which is formed by combining different portions of the scene. The disclosed apparatus includes a hybrid dual-lens extended panoramic camera with one lens that is mounted in a movable assembly. Images are taken simultaneously through each lens on two different media: photographic film and an image sensor. However, the separate media can also be of the same type so that two different photographic films or two separate image sensors may also be used.

Such conventional technologies suffer from several drawbacks. For example, two sets of image data are required to be stored in the camera until that information can be transferred and combined by another computer. Consequently, the camera memory will reach its maximum data capacity with only half as many scenes than it could otherwise store. Furthermore, even with sufficient memory capacity, there is no way to crop a combined image in order to reduce these memory requirements and/or create a more aesthetically pleasing composition.

### SUMMARY

These and other drawbacks of conventional technology are addressed here by providing a digital camera comprising a means capturing at least one image of a scene, a means for displaying the captured image, means for cropping the displayed image, and means for storing an uncropped portion of the displayed image. Also provided is a method of controlling a digital camera comprising the steps of receiving at least one captured image from a photosensor, displaying the captured image, receiving cropping instructions for the displayed image, and storing an uncropped portion of the displayed image.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of an embodiment of a dual-lens camera according to the present invention.

FIG. 2 is a back view of the camera shown in FIG. 1.

FIG. 3 is a series of example display screens from the back of the camera shown in FIG. 2.

FIG. 4 is a flow diagram for a method according to the present invention of controlling the operation of the camera shown in FIGS. 1 and 2.

### DETAILED DESCRIPTION OF THE PREFERRED EMBODIMENTS

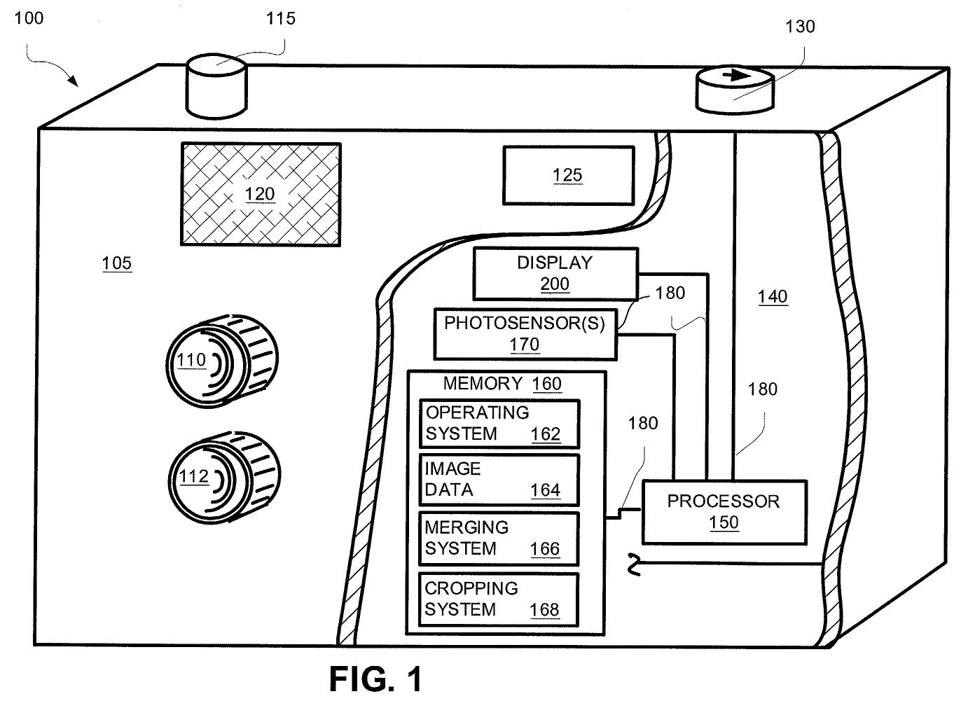

FIG. 1 is a schematic diagram of a dual-lens camera 100. Although FIG. 1 is illustrated as a digital camera for taking still photographs, a variety of other cameras may be similarly configured, including film cameras, video cameras, motion picture cameras, and other devices that capture and/or record image information. The camera 100 includes a body 105 that supports lenses 110 and 112, shutter control 115, flash 120, view finder 125, and control knob 130. The camera 100 may also be provided with a variety of other components, such as additional lenses, a flash sensor, range finder, focal length control, microphone, and/or other features. The system can also be used to set the focal point since it is presumed the user will center the subject in the view finder, the subject should be slightly off center in each lens. Focus can then be set based on this information.

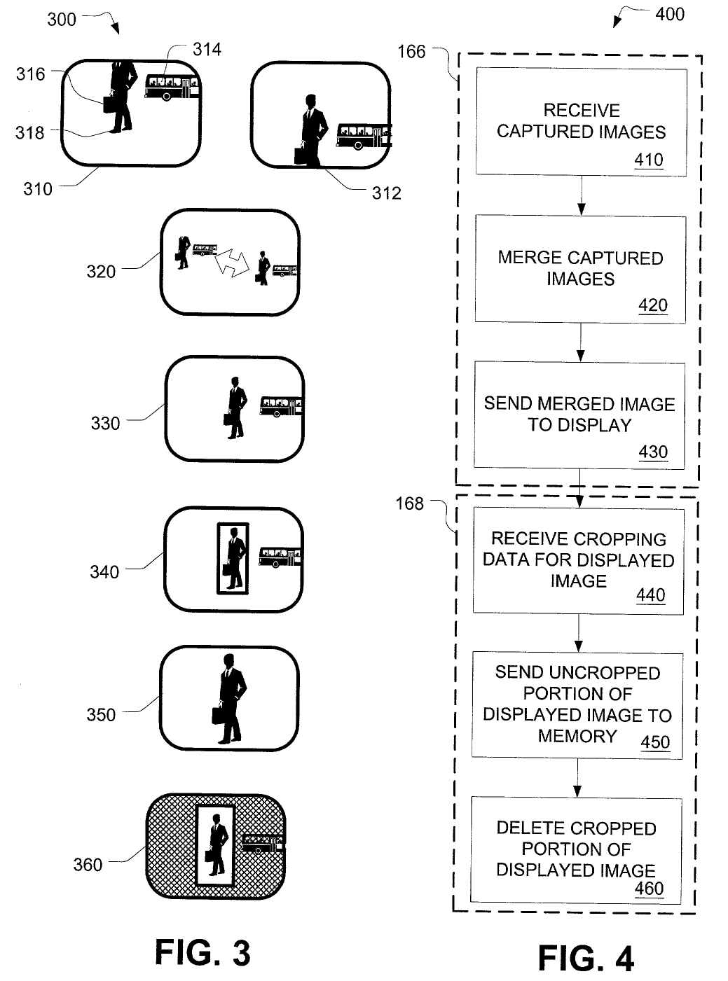

As discussed in more detail below, the lenses 110 and 112 are preferably arranged to provide different images of the same scene. For example, lens 110 may provide a wide-angle image of a certain field of view while lens 112 provides a telephoto image of just a portion of the same field of view. However, lenses 110 and 112 preferably provide the same magnification for different fields of view in the same scene. For example, although not shown in FIG. 1, one or both of the lenses 110 and 112 may be mounted on a movable assembly, so that each lens may be aimed at overlapping fields of view for the same scene, as described in more detail below with respect to FIGS. 3 and 4. The shutters for the two lenses are preferably interlocked in order to work together. For example, simultaneous operation or different times of exposure for the lenses 110, 112 will allow the user to control contrast and brightness after the photo is taken.

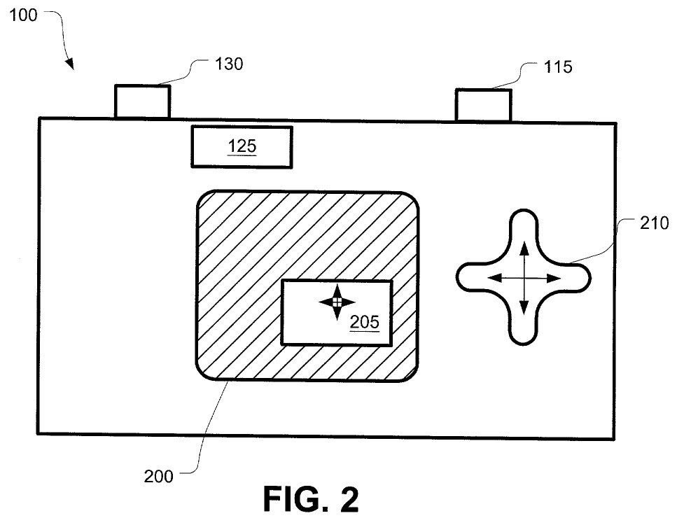

FIG. 2 is a back view of the camera 100 showing the display 200 for displaying image data 164. The display 200 includes a cropping window 205, which is moveable about the display using cropping control 210. The cropping window 205 may be moved about the display 200 and/or changed in dimension using the cropping control 210, as described in more detail below.

Returning to FIG. 1, this figure also shows a block diagram of certain components for implementing a photo system 140 for managing various operational aspects of the camera 100 as described in more detail below. The photo system 140 may be implemented in a wide variety of electrical, electronic, computer, mechanical, and/or manual configurations. However, in a preferred embodiment, the photo system 140 is at least partially computerized with various aspects of the system being implemented by software, firmware, hardware, or a combination thereof.

In terms of hardware architecture, the preferred photo system 140 includes a processor 150, memory 160, and one or more input and/or output (“I/O”) devices, such as display 200, photosensor(s) 170, switch 130, flash 120, and/or shutter control 115. Although not shown in FIG. 1, light sensors, exposure controls, microphones, and/or other I/O devices may also be provided and may include their own memory and processors. Each of the I/O devices is communicatively coupled via a local interface 180 to the processor 150. However, for the sake of simplicity, the interface 180 for the flash 120 and shutter control 115 are not shown in FIG. 1.

The local interface 180 may include one or more buses, or other wired connections, as is known in the art. Although not shown in FIG. 1, the interface 180 may have other communication elements, such as controllers, buffers (caches) driver, repeaters, and/or receivers. Various address, control, and/or data connections may also be provided with the local interface 180 for enabling communications among the various components of the computer 140.

The camera 100 may include one or more photosensors 170. Preferably, a photosensor 170 is provided for each of the lenses 110 and 112. However, additional or fewer photosensor(s) and/or lenses may also be provided. The photosensor(s) 170 are preferably charge-coupled devices or complimentary metal-oxide semi conductor sensors for capturing image data. However, a variety of other photosensing technologies may also be used.

The memory 160 may have volatile memory elements (e.g., random access memory, or “RAM,” such as DRAM, SRAM, etc.), nonvolatile memory elements (e.g., hard drive, tape, read only memory, or “ROM,” CDROM, etc.), or any combination thereof. The memory 160 may also incorporate electronic, magnetic, optical, and/or other types of storage devices. A distributed memory architecture, where various memory components are situated remote from one another, may also be used.

The processor 150 is preferably a hardware device for implementing software that is stored in the memory 160. The processor 150 can be any custom-made or commercially available processor, including semiconductor-based microprocessors (in the form of a microchip) and/or macroprocessors. The processor 120 may be a central processing unit (“CPU”) or an auxiliary processor among several processors associated with the computer 100. Examples of suitable commercially-available microprocessors include, but are not limited to, the PA-RISC series of microprocessors from Hewlett-Packard Company, U.S.A., the 80×86 and Pentium series of microprocessors from Intel Corporation, U.S.A., PowerPC microprocessors from IBM, U.S.A., Sparc microprocessors from Sun Microsystems, Inc, and the 68xxx series of microprocessors from Motorola Corporation, U.S.A.

The memory 160 stores software in the form of instructions and/or data for use by the processor 150. The instructions will generally include one or more separate programs, each of which comprises an ordered listing of executable instructions for implementing one or more logical functions. The data will generally include a collection of user settings and one or more stored media data sets corresponding to separate images that have been captured by camera 100. In the particular example shown in FIG. 1, the software contained in the memory 160 includes a suitable operating system (“O/S”) 162, along with image data 164, a merging system 166, and a cropping system 168.

The operating system 162 implements the execution of other computer programs, such as the merging and cropping systems 166 and 168, and provides scheduling, input-output control, file and data management, memory management, communication control, and other related services. Various commercially-available operating systems 160 may be used, including, but not limited to, the DigitaOS operating system from Flashpoint Technologies, U.S.A., the Windows operating system from Microsoft Corporation, U.S.A., the Netware operating system from Novell, Inc., U.S.A., and various UNIX operating systems available from vendors such as Hewlett-Packard Company, U.S.A., Sun Microsystems, Inc., U.S.A., and AT&T Corporation, U.S.A.

In the architecture shown in FIG. 1, the merging system 166 and cropping system 168 may be a source program (or “source code”), executable program (“object code”), script, or any other entity comprising a set of instructions to be performed as described in more detail below. In order to work with a particular operating system 162, any such source code will typically be translated into object code via a conventional compiler, assembler, interpreter, or the like, which may (or may not) be included within the memory 160. The merging and/or cropping systems 166 and 168 may be written using an object-oriented programming language having classes of data and methods, and/or a procedure programming language, having routines, subroutines, and/or functions. For example, suitable programming languages include, but are not limited to, C, C++, Pascal, Basic, Fortran, Cobol, Perl, Java, and Ada.

When the merging system 166 and cropping system 168 are implemented in software, as is shown in FIG. 1, they can be stored on any computer readable medium for use by, or in connection with, any computer-related system or method, such as the photo system 140. In the context of this document, a “computer readable medium” includes any electronic, magnetic, optical, or other physical device or means that can contain or store a computer program for use by, or in connection with, a computer-related system or method. The computer-related system may be any instruction execution system, apparatus, or device, such as a computer-based system, processor-containing system, or other system that can fetch the instructions from the instruction execution system, apparatus, or device and then execute those instructions. Therefore, in the context of this document, a computer-readable medium can be any means that will store, communicate, propagate, or transport the program for use by, or in connection with, the instruction execution system, apparatus, or device.

For example, the computer readable medium may take a variety of forms including, but is not limited to, an electronic, magnetic, optical, electromagnetic, infrared, or semiconductor system, apparatus, device, or propagation medium. More specific examples of a computer-readable medium include but is not limited to an electrical connection (electronic) having one or more wires, a portable computer diskette (magnetic), a random access memory (“RAM”) (electronic), a read-only memory (“ROM”) (electronic), an erasable programmable read-only memory (“EPROM,” “EEPROM,” or Flash memory) (electronic), an optical fiber (optical), and a portable compact disc read-only memory (“CDROM”) (optical). The computer readable medium could even be paper or another suitable medium upon which the program is printed, as the program can be electronically captured, for instance via optical sensing or scanning of the paper, and then compiled, interpreted or otherwise processed in a suitable manner before being stored in the memory 160.

In another embodiment, where either or both of the merging system 166 and cropping system 168 are at least partially implemented in hardware, the system may be implemented using a variety of technologies including, but not limited to, discrete logic circuit(s) having logic gates for implementing logic functions upon data signals, application specific integrated circuit(s) (“ASIC”) having appropriate combinational logic gates, programmable gate array(s) (“PGA”), and/or field programmable gate array(s) (“FPGA”).

Once the photo system 140 is accessed, the processor 150 will be configured to execute instructions in the operating system 162 that are stored within the memory 160. The processor 150 will also receive and execute further instructions in connection with the image data 164, so as to generally operate the system 140 pursuant to the instructions and data contained in the software and/or hardware as described below with regard to FIGS. 3 and 4.

FIG. 4 is a flow diagram for one embodiment of the merging system 166 and cropping system 168 that are shown in FIG. 1. FIG. 3 illustrates a series of example screens 300 that are depicted on display 200 and generally correspond to the flow diagram in FIG. 4. More specifically, FIG. 4 shows the architecture, functionality, and operation of an embodiment of a software system 400 for implementing the merging system 166 and cropping system 168 of the photo system 140 shown in FIG. 1. However, as noted above, a variety of other computer, electrical, electronic, mechanical, and/or manual systems may be similarly configured.

Each block in FIG. 4 represents an activity, step, module, segment, or portion of computer code that will typically comprise one or more executable instructions for implementing the specific logical function(s). It should also be noted that, in various alternative implementations, the functions noted in the blocks will occur out of the order noted in FIG. 4. For example, multiple functions in different blocks may be executed substantially concurrently, in a different order, incompletely, and/or over an extended period of time, depending on the functionality involved. Various steps may also be completed manually. They may also be executed automatically, in part or in whole.

In FIGS. 3 and 4, the images that are captured by each of the lenses 110 (FIG. 1) and 112 (FIG. 1) are received from the memory 160 (FIG. 1) by the merging system 166 at step 410. As shown by the two screens 310 and 312 at the top of FIG. 3, the lenses 110 and 112 are preferably aimed so as to capture different portions, or fields of view, of the same scene. More particularly, screens 310 and 312 show images that have a partially-overlapping image field for the central portion of the scene which includes the bus 314, and briefcase 316 carried by the person 318. However, the two images may also be completely overlapping with substantially the same field of view. The images are preferably captured at substantially the same time in order to prevent any differences caused by movement of the subject matter. However, the images may also be captured sequentially in time, particularly if there is little or no movement of the subject matter.

Returning to FIG. 4, at step 420, the captured images 310 and 312 are merged into a single image, as depicted in screen 320. At step 430, the merged images are then displayed, as depicted in screen 330. The merging system 166 thus allows an improperly composed image (such as that shown in screen 310 where the person's head has been cut off) to be merged with additional image data from the other lens (as shown in screen 312 where the person's legs are cut off) in order to provide the single complete image shown in the screen 330.

However, the screen 330 shows an image that is likely to require a large amount of space in memory 160, since it includes both sets of data from screens 310 and 312. Therefore, the cropping system 168 is provided in order to allow a user to select only certain image data 164 from the screen 330 for storage in the memory 160 (FIG. 1).

Returning to FIG. 4, steps 440 through 460 illustrate a flow diagram for an embodiment of the cropping system 168 according to the present invention. At step 440, cropping data for the displayed image is received (or retrieved) from the display. For example, as shown in screen 340, a user might position and size the cropping 110 window 205 around the person 318 shown in the screen. At step 450, the uncropped portion of the displayed image shown in screen 350 is sent to memory 160. Finally, at step 460 and as shown in FIG. 3, the cropped portion of the merged images in screen 360 is deleted so that additional space is available in memory 160 for other images. Thus, in this specific example, a user is able to obtain the desired image of the entire person 318, and only the person, using the minimum amount of memory 160.

1. A digital camera, comprising:
means for capturing at least one image of a scene;
means for displaying said at least one captured image;
means for cropping the displayed at least one captured image; and
means for storing an uncropped portion of the displayed at least one captured image.

2. The digital camera recited in claim 1, further comprising means for deleting a cropped portion of displayed image.

3. The digital camera recited in claim 1 wherein said capturing means captures at least two images of the scene.

4. The digital camera recited in claim 3, further comprising means for merging the two captured images into the displayed image.

5. The digital camera recited in claim 1 wherein said at least two images of the scene are captured sequentially in time.

6. The digital camera recited in claim 4 wherein said at least two images of the scene are captured simultaneously.

7. The digital camera recited in claim 3 wherein said at least two images have an overlapping image field.

8. The digital camera recited in claim 3 wherein said at least two images have substantially the same image field.

9. A method of controlling the operation of a digital camera, comprising the steps of:
receiving at least one captured image from a photosensor;
displaying the captured image;
receiving cropping instructions for the displayed image;
storing an uncropped portion of the displayed image.

10. The method recited in claim 9 further comprising the step of deleting a cropped portion of the displayed image.

11. The method recited in claim 9 wherein said receiving step further comprises receiving at least two captured images from the photosensor.

12. The method recited in claim 11, further comprising the step of:
merging the two captured images into the displayed image.

13. The method recited in claim 11 further comprising the step of capturing said at least two images sequentially in time.

14. The method recited in claim 11 further comprising the step of capturing said at least two images simultaneously.

15. The method recited in claim 14 wherein said at least two images have an overlapping image field.

16. The method recited in claim 12 wherein said two images have the same image field.

17. A computer readable medium for controlling the operation of a digital camera, comprising:
logic that receives at least one captured image from a photosensor;
logic that displays the at least one captured image;
logic that receives cropping instructions for the displayed at least one captured image;
logic that stores an uncropped portion of the displayed at least one captured image; and
logic that deletes a cropped portion of the displayed image prior to storing the uncropped portion of the displayed image.

18. The computer readable medium recited in claim 17 wherein said receiving logic comprises further logic that receives at least two captured images from the photosensor.

19. The computer readable medium recited in claim 17 further comprising logic that merges the two captured images into the displayed image.

20. The computer readable medium recited in claim 18 wherein said at least two captured images are captured sequentially in time.

21. The computer readable medium recited in claim 18 wherein said two images are captured simultaneously.

22. The computer readable medium recited in claim 21 wherein said two images have a n over lapping image field.

23. The computer readable medium recited in claim 22 wherein said two images have the same image field.
